(19) United States
(12) Patent Application Publication
(10) Pub. No.: US 2006/0254650 A1
(43) Pub. Date: Nov. 16, 2006

(54) Composite faucet

(75) Inventors: Shinn-Tyan Wu, Taoyuan Shieh (TW); Wei-Chuan Chen, Taoyuan Shieh (TW)

Correspondence Address: TROXELL LAW OFFICE PLLC, SUITE 1404, 5205 LEESBURG PIKE, FALLS CHURCH, VA, 22041, US

(73) Assignee: WAYS TECHNICAL CORP., LTD.

(21) Appl. No.: 11/411,789

(22) Filed: Apr. 27, 2006

(30) Foreign Application Priority Data
May 12, 2005 (TW) 94207676

(51) Int. Cl. F16K 27/06

(52) U.S. Cl. 137/375

(57) ABSTRACT

A composite faucet includes a body coated with refractory material, the body directly contacting with water is made of metallic alloys; the body already coated with refractory material is further covered with a plastic material by injection for easier fabrication.

### BACKGROUND OF THE INVENTION

(a) Field of the Invention

The present invention is related to a composite faucet, and more particularly, to one comprised of internal and external parts to allow fast manufacturing process and quality composite structure.

(b) Description of the Prior Art

The conventional mixer valve is usually cast molded in a construction as illustrated in FIGS. 1 and 2 of the accompanying drawings. Thought it provides water on/off, and water flow and temperature adjustment functions, its body is cast molded. Core shell is first placed at where the hollow cavity is located before injecting into the metallic liquid for the hollow waterway in the body. During the process, both of the speed and acceptability of mass production are affected due to difficulties in locating the core shell. Furthermore, the body so molded by casting requires further grinding and polishing processes that consume lost of time, money and labor. Furthermore, residual metallic powders after grinding and polishing processes create serious environmental problem.

To correct those problems, an improved structure of Taiwan Utility Patent Publication No. 284265 titled “Plastic Injection Molded Mixer Valve” as illustrated in FIG. 3 teaches a mixer valve that has its hollow plastic components of waterway, spout and valve chamber entirely injection molded before being adapted to a body. And a plastic faucet is produced by having the body placed in a mold to be wrapped up with an external part by injection mold with multiple holes formed in relation to the valve chamber, cold water hole, hot water hole, and water supply lines that to be communicated to external components. However, waterway of the plastic material directly contacts hot water and cold water. Hot water brings serious thermal impact upon the plastic material when the hot water direct contacts the plastic waterway. Whereas the heat withstanding capacity of the plastic material is comparatively weaker, the faucet suffers the problem of shorter service life. Furthermore, the water of higher temperature with longer time of use could cause chemical substances in the plastic material to get solved in the hot water thus to pollute the water quality. Accordingly, merchandising for the plastic faucet is frustrated and actually it is rare for the plastic faucet to become generally available in the market.

### SUMMARY OF THE INVENTION

The primary purpose of the present invention is to provide a composite faucet essentially comprised of a body including metal components of cold waterway, hot waterway, water inlet, water outlet, and valve chamber. The body allows both of hot and cold water flowing in the metallic waterway. Whereas metallic material yields excellent thermal withstanding and duration properties, it is ideal in the production of duration faucet to prevent water quality from being contaminated by the dissolved chemical substances when the plastic material contacts hot water. The body already coated with the refractory material is placed in a mold to be packaged with a plastic layer by means of pouring and injection to produce a composite faucet. Sine the body is coated with the refractory material, the heat from the hot water will not be so easily conducted to the plastic material in the package layer thus to maintain the expected service life of the faucet by protecting the package layer from being vulnerable to thermal impacts. With the presence of the refractory material separates the heat conduction while the hot water flows through the metallic waterway, the heat of the hot water will not be directly sensed by toughing the surface of the package layer, thus to prevent burns by the faucet. Furthermore, the present invention permits fast production at lower cost to yield attractive appearance due to that the body is contained by the refractory material, the grinding and polishing processes as warranted by metallic faucet of the prior art can be skipped thus to prevent serious pollution problems from the residuals of the grinding and polishing processes.

### BRIEF DESCRIPTION OF THE DRAWINGS

FIG. 1 is a vertical sectional view of a faucet of the prior art.

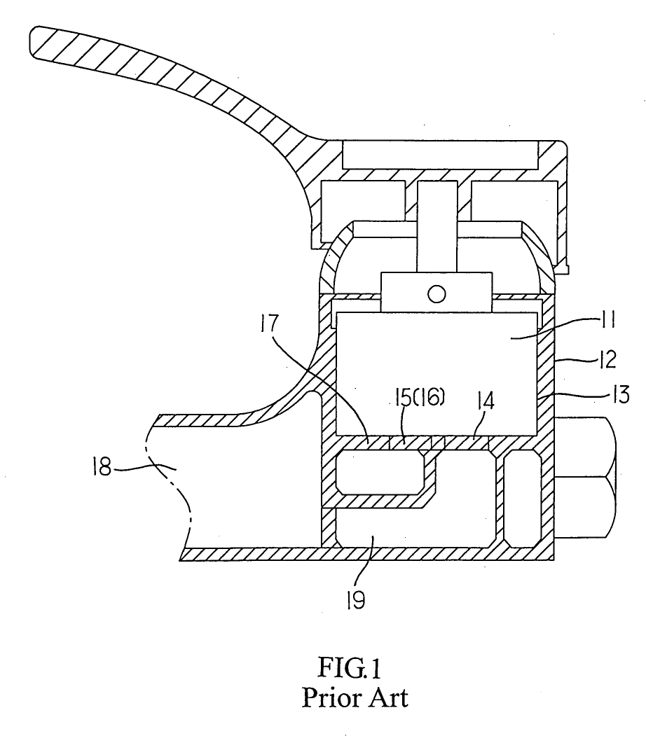

FIG. 2 is a cross sectional view of the faucet of the prior art.

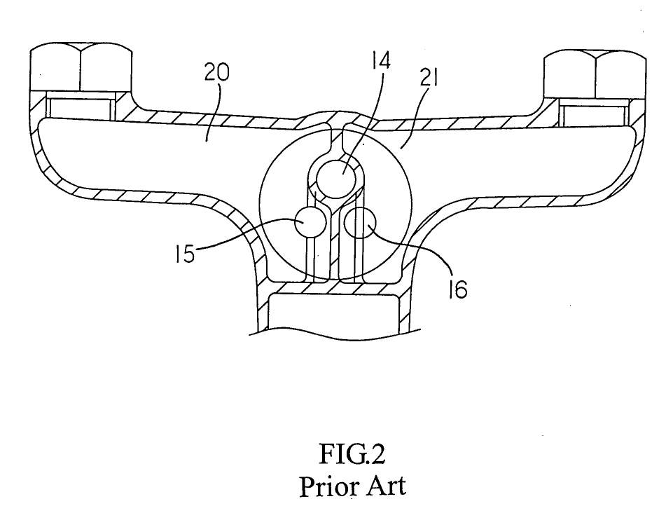

FIG. 3 is another cross sectional view of the faucet of the prior art.

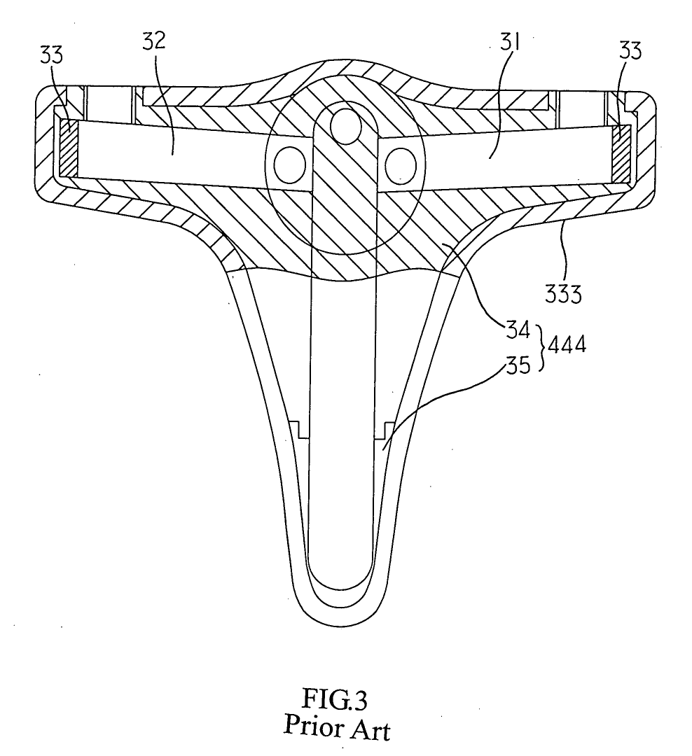

FIG. 4 is a cross sectional view of a preferred embodiment of the present invention.

### DETAILED DESCRIPTION OF THE PREFERRED EMBODIMENTS

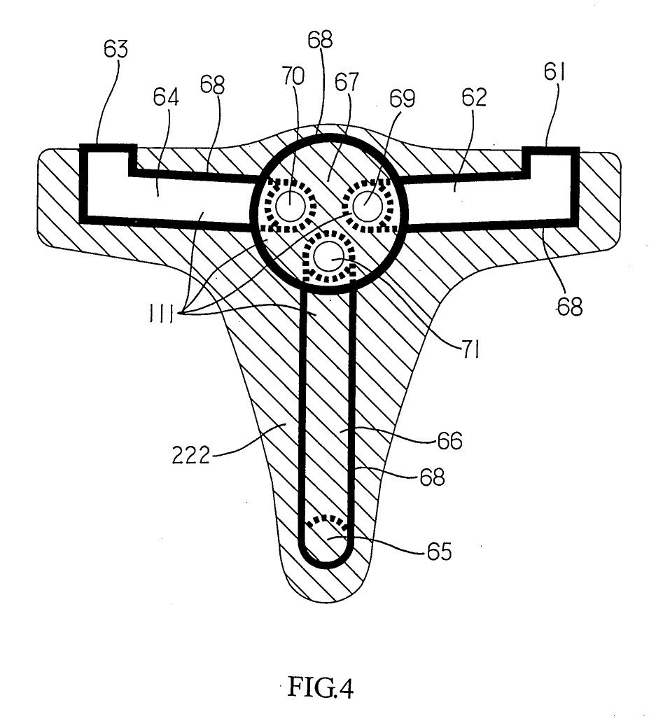

Referring to FIG. 4 for a preferred embodiment of the present invention, a composite faucet is comprised of a body 111 coated with a refractory material 68 and a package layer 222 of plastic material injection molded. The body 111 includes multiple metallic components connected to one another, respectively, a cold waterway 62, a hot waterway 64, a water outlet 66, and a valve chamber 67 (to accommodate a water flow regulating valve). Wherein, one end each of the cold waterway 62, the hot waterway 64, and the water outlet 66 is connected through the valve chamber 67. A cold water inlet 61 of the cold waterway 62, a hot water outlet 63 of the hot waterway 64, and the water outlet 66 respectively form an opening 65 to keep water flowing through in the composite faucet. The body 111 coated with the refractory material 68 is placed in a mold to be covered up with the package layer 222 by means of plastic injection. Accordingly, the composite faucet of the present invention is comprised of metallic body 111 and the plastic package layer 222. Wherein, the valve chamber 67 contains a control valve (not illustrated) to control the cold water flowing from the cold-water inlet 69 and the hot water flowing from the hot water inlet 70 before being mixed to flow out of a spout 71.

Alternatively the package layer 222 may be made of potter's clay or any other natural or man-made material. To eliminate the possible dissolution of the chemical substance from the plastic supply line where hot water flows, the body 111 is comprised of multiple metallic components connected to one another. However, if the body 111 is comprised of plastic cold waterway, hot waterway, water outlet and valve chamber, a metallic film is applied on the inner wall of each plastic component where contacts the water. A material of the metallic film that will not release hazardous substances in to the water is preferred so to overcome the possible presence of dissolved chemical substances in the plastic supply lines when the heat water flows through. Accordingly, the body 111 whether comprised of multiple components that may be strictly made of metallic material or plastic material with their inner wall coated with a metallic film, or any combination of both. Furthermore, the body 111 is made integrated with all metallic components by casting, or with all plastic components coated on their inner walls with a metallic film by injection mold before further being coated with the refractory material 68 and the package layer 222 to achieve the same purpose of correcting the flaws found with the prior art. The surface of the package layer 222 may be further processed for the composite faucet to indicate the quality other than that by plastic materials. For example, the surface of the package layer 222 may be processed with metallic film or coated with metallic powder for the composite faucet to display the metallic quality or the ceramic quality when enameled. The material of the package layer 222 may be fixed with other materials in different color and nature to produce the faucet in diversified appearance.

The prevent invention provides an improved structure of a composite faucet, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A composite faucet includes a metal body comprised of a cold waterway, a hot waterway, a water outlet, and a valve chamber; the cold water passage, the hot water passage, and one end of the water outlet passage being connecting through the valve chamber; the cold waterway, the hot waterway, and another end of the water outlet being respectively provided with an opening for the water to flow through; and a package layer wrapping up the exterior of the body.

2. A composite faucet of claim 1, wherein a refractory material is further disposed at where between the body and the package layer to separate heat conduction.

3. A composite faucet of claim 1, wherein the metal body is comprised of multiple metallic components connected to one another.

4. A composite faucet of claim 1, wherein, the metal body relates to a single body.

5. A composite faucet includes a body having its inner wall coated with a metallic film; the body including a cold waterway, a hot waterway, a water outlet, and a valve chamber; the cold water passage, the hot water passage, and one end of the water outlet passage being connecting through the valve chamber; the cold waterway, the hot waterway, and another end of the water outlet being respectively provided with an opening for the water to flow through; and a package layer wrapping up the exterior of the body.

6. The composite faucet of claim 5, wherein a refractory material is further provided at where between the body and the package layer to separate heat conduction.

7. The composite faucet of claim 5, wherein the metal body is comprised of multiple metallic components connected to one another; and one or a plurality of those components includes a metal film on its inner wall.

8. The composite faucet of claim 5, wherein, the body relates to a single body with its inner wall coated with a metal film.
